(19) United States
(12) Patent Application Publication
(10) Pub. No.: US 2006/0143083 A1
(43) Pub. Date: Jun. 29, 2006

(54) System and method for providing electronic information relating to printed advertisements

(76) Inventor: Peter S. Wedeen, Wilmington, VT (US)

Correspondence Address: MCCORMICK, PAULDING & HUBER LLP, CITY PLACE II, 185 ASYLUM STREET, HARTFORD, CT, 06103, US

(21) Appl. No.: 11/319,682

(22) Filed: Dec. 28, 2005

Related U.S. Application Data
(60) Provisional application No. 60/639,769, filed on Dec. 28, 2004.

(51) Int. Cl. G06Q 30/00

(52) U.S. Cl. 705/14

(57) ABSTRACT

The present invention relates to a system and method for providing information about commercial opportunities located at disparate locations through the use of corresponding print and electronic records.

### RELATING TO PRINTED ADVERTISEMENTS

This application claims the benefit of U.S. Provisional Application No. 60/639,769, filed on Dec. 28, 2004, the contents of which are herein incorporated by reference in their entirety.

### FIELD OF INVENTION

The invention relates to the fields of advertising and information technology. More particularly, the invention relates to a system and a method that allows a seller/advertiser to enter additional detailed and expanded information pertinent to a published advertisement (ad) on a website.

### BACKGROUND OF THE INVENTION

Individuals wanting to sell goods and services place printed advertisements through newspapers or other types of printed publications. Print advertisements such as classified advertisements cover a broad range of services and goods to assist potential buyers in finding items ranging from household goods, personal effects, boats, cars, real estate, etc. The individual seller initiates the process by placing the desired ad through the newspaper or periodical usually via a phone call or email to the advertising staff of a particular newspaper. In most cases, the newspaper's advertising staff assist the seller/advertiser in forming and wording a three or more line classified printed ad. Due to the cost and space constraints, print advertisements are often severely limited in the amount of information displayed, as the per-line or per-word fee charges for such advertisements generally discourage lengthy or specific descriptions.

Consequently, an advertiser may not be able to fully convey all of the information that a potential buyer would like to have. For example, it would be cost prohibitive for the seller to list every item in a tag sale featuring hundreds of separate items. Further, because such an advertisement would not provide an exhaustive list of items for sale, a potential buyer would have to aimlessly drive from sale to sale in the hopes of finding a special item she is looking for.

Yet another limitation of traditional classified advertising is that because multiple periodicals often circulate in the same region, ads must be placed in multiple periodicals to reach the entire potential market, an expensive prospect. Accordingly, an advertiser will often choose to place the ad in only one publication. Market exposure of the ad is therefore limited.

In an attempt to surmount the limitations of classified advertising in print media alone, the publishers of print media often make the same ads available over the Internet on their own dedicated website. Because there is not a consolidated method and system where print advertisements from different publications can be viewed electronically from a single source by potential buyers, advertisements must be searched through each of the individual publication websites—a time consuming and inefficient process. Moreover, in the instance where a newspaper has their own website, in most cases what appears on these websites is the identical three or four line classified ad originally placed in their printed classified ad section of a newspaper without any additional information being added on the newspaper's dedicated website about the product or service being offered.

Once a potential buyer has searched and found ads which contain items of interest, she must then determine whether or not it is feasible or convenient to visit the sale locations of most interest, taking into consideration the time and distance from her home to the sale location. Additional information about the items being sold, in some instances, can be attained by the buyer simply calling seller's listed phone number. However, in most instances, for example with tag sales, the seller does not list her telephone number in her printed classified ad because she does not want to be bothered with numerous phone inquiries. Also, the seller does not want to consistently repeat driving directions to each and every potential buyer who calls.

Another tedious chore for the potential buyer of these sales is to study a road map to determine where the printed tag sales are located and what is the most efficient route to all various garage sales she wishes to visit in the same day that have been listed in her local newspapers. Unfortunately for the buyer, most road maps do not give the detail of individual streets or house numbers for precise street locations. However, even if the ad reader/buyer has located individual sale street addresses on her road map, she must still develop a logical time and distance itinerary for traveling from sale site to sale site. The difficulty of planning and prioritizing sites and route planning is further aggravated by the fact that the buyer has a limited time window of opportunity to visit the sale sites of the greatest interest and of most importance. For example, yard or tag sales, as well as “open house” sessions, are often available only for a few hours on a selected day. Although mapping software exists on the Internet to find and graphically display a location and provide sequential driving directions to a selected address, such does not exist in the context of classified type advertising.

### SUMMARY OF THE INVENTION

A system has been developed for providing information about commercial opportunities which include items and/or services located at disparate locations. In the system, printed publications offer printed advertisements to people selling an item or offering a service in which the printed advertisement in the printed publication has a corresponding electronic advertisement on a website of the invention. The electronic advertisement contains additional, detailed information regarding the item for sale or service offered that is not present in the printed advertisement.

The system of the invention can further include having additional information entered by the person of the first defined class into an electronic record, which record includes greater detail than that of the print record. The print record is published or placed into a printed periodical. The published print record includes an indicia associated with the print record indicating the existence of expanded information on an electronic record corresponding to the print record. The ad reader or person of the defined second class of persons, being alerted by the printed indicia, can now access the electronic records through a communications network to retrieve additional information pertinent to the print record. This additional information/data is stored in the database of the invention and can be accessed by connecting to the website of the invention.

In addition, the system of the invention allows the person of the second defined class of persons to make a selection of electronic records of interest and retrieve from the database detailed driving directions and geographical coordinates in order to precisely locate their disparate locations of the individual selected records. The person of a second defined class of persons can manipulate the data from the subset to create a travel itinerary comprised of sequential driving directions and/or map views and/or geographical coordinates defined by the their preselected designated criteria as retrieved from the data records. This designated criteria includes, but is not limited to, shortest travel distance, shortest travel time, and/or order of electronic record preference. This method allows the buyer/ad reader the opportunity to be exposed and have access to all classified ads published in their region or chosen travel radius with additional detailed information included. With this method, the ad reader does not have to purchase several regional newspapers to be exposed to every classified type of advertisement published. This same system allows the seller/advertiser to place only one classified ad in only one chosen newspaper, yet has the exposure and the circulation of all newspapers published in her region. In fact, with this present invention, the seller gets the greatest exposure to the entire potential and targeted market by publishing her advertisement in only one publication, rather than having to make the choice among several newspapers available to advertise with in her area In other words, the method provides a reader/buyer with “one-stop shopping” to find detailed information on all classified ads placed in all affiliated publications which participate in the system of the invention.

Additionally, the ad reader/buyer needs only to purchase one newspaper (as opposed to buying several local publications), have a computer which can access the Internet, and simply go directly to the website of the invention to access and locate the total amount of information and/or ads published in her region that are most pertinent to her desired items or services of interest. With the integrated newspaper method of the invention, both the buyer and seller is assured that she, the buyer, has been made aware and/or has discovered all classified ads printed by one or more newspapers within her travel radius. At the same time, the seller is also assured that her advertisement has reached the largest possible targeted population or market.

The system and method of the invention will increase the profit potential and margin for both the printed publication (e.g., newspaper) as well as the classified advertiser selling her product and will also fulfill the needs and requirements of the ad reader/buyer who in most cases, requires further detailed information than the typical three or four line classified ad provides. The invention fulfills the advertiser's optimal goal of locating the targeted and largest market for their product or service while simultaneously assuring the buyer/reader that they have been exposed to the greatest selection of items “for sale” while being given the most information possible pertinent to these items in order to facilitate the process of locating items or services they are seeking or in need of more expeditiously. Using the method of the invention, the seller has expressed all the important and crucial information necessary and pertinent to selling her product while in the same instance the buyer has received the most comprehensive and detailed information about the item or service they wish to purchase, without going to the effort of having to contact the advertiser directly, who may in fact, want to remain anonymous and/or not want to answer tedious and usually repetitious inquires.

### DESCRIPTION OF THE DRAWINGS

FIG. 1 is a flow diagram of the system of the invention.

FIG. 2 is an illustration of several components of the invention.

FIG. 3 is a diagram showing a step of the method of the invention.

FIG. 4 is a diagram showing a step of the method of the invention.

FIG. 5 shows a travel itinerary generated by the method of the invention.

FIG. 6 is a flow diagram of the system of the invention.

### DETAILED DESCRIPTION

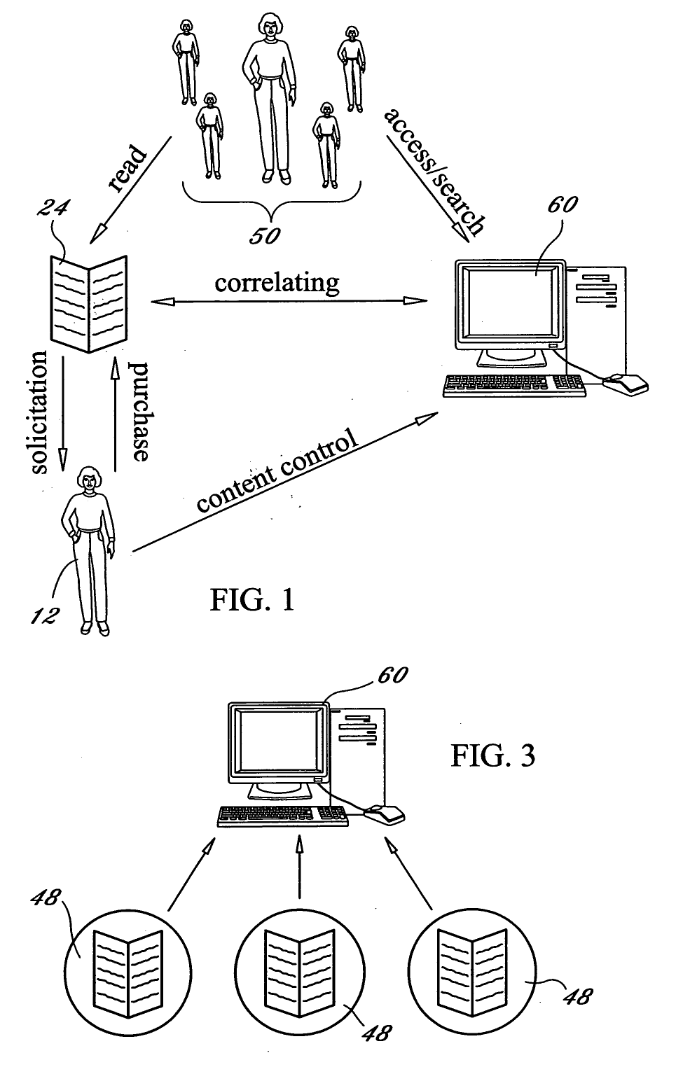

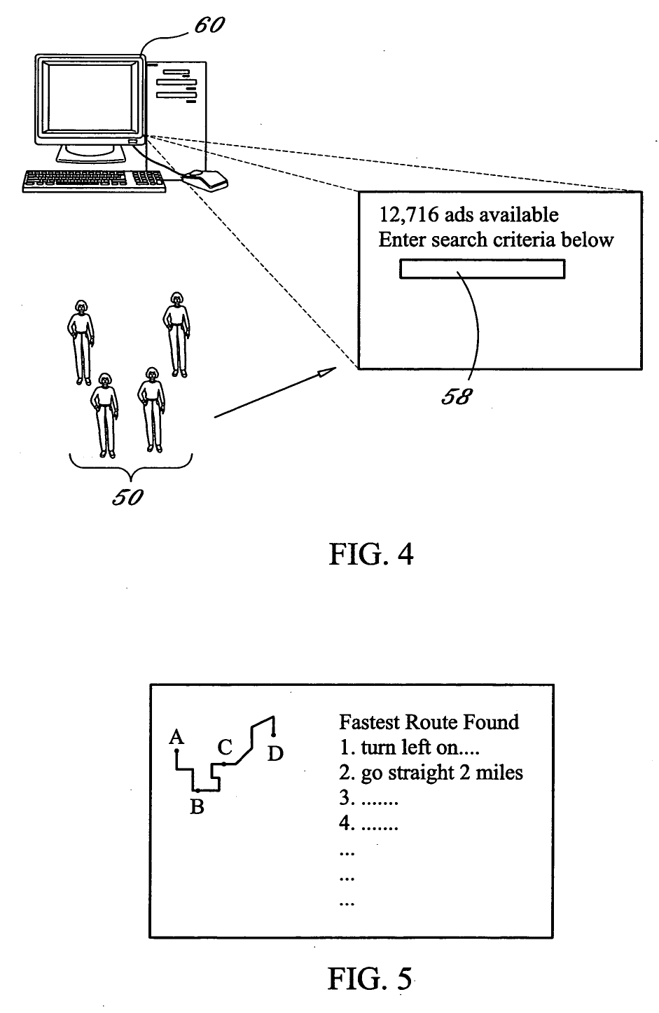

The invention encompasses a system and method for providing additional electronic information relating to advertisements printed in various types of publications. In brief overview, referring to FIGS. 1-6, an embodiment of the method of the invention includes providing detailed information and content to further enhance typical classified advertisements placed in the classified section of most newspapers and other types of publications 24. As illustrated in FIG. 1, a classified advertiser 12 of a defined class of persons contacts a publication 24 to place a typical brief lineage classified ad. The publication then solicits the advertiser to create a more comprehensive electronic record 18 as an addendum to the original printed record.

The electronic record can be in the form of an advertisement, and may contain any information including words, photos or data that the person 12 (the advertiser) would like to add to her printed record and communicate to persons 50 (ad readers/buyers). The defined class of person 12 can be any advertiser or individual who desires to offer an item or service for sale and communicate further detailed information concerning the attributes and availability of a particular opportunity or offering of goods or services. Solicitation by the publication's ad representative of the electronic record 18, from the person 12 can be via telephone, the Internet, or by any other suitable communicative means.

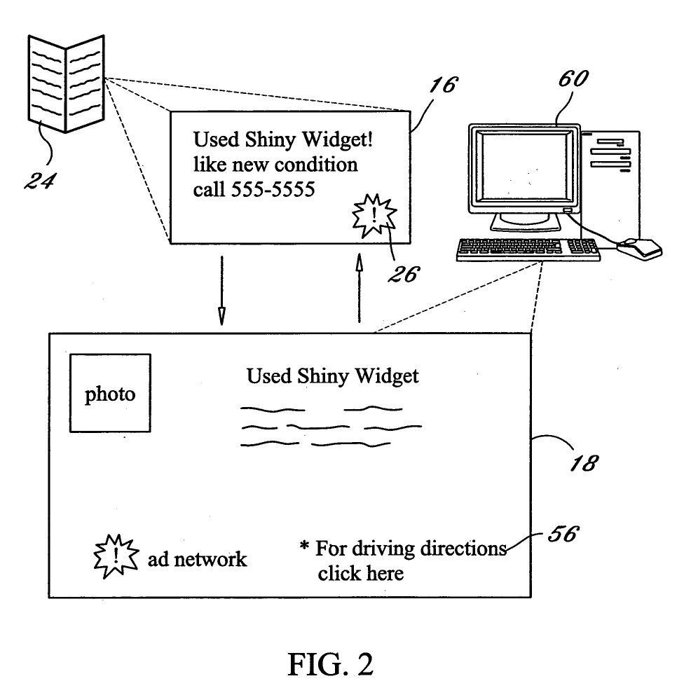

Subsequently, a print record 16, (the printed classified ad) shown in FIG. 2, is created and published in print form by an intermediary, such as a publisher of a newspaper or other periodical, utilizing the data provided by the person 12 to form a typical four or five line classified type ad. In addition to the print record 16, an electronic record 18 (also shown in FIG. 2) is created and is accessible over a communications network, such as the provider 60 (website of the invention). The data contained in either the print record or the electronic record can include text, images, contact information, and geographical information leading to the location of the item being offered. The print record 16 is then published in a print periodical 24, and employs an indicia 26 that indicates to a reader or potential buyer the existence of corresponding extended detailed and/or comprehensive content entered on the electronic record 18, as depicted in FIG. 2. Such an indicia can be a reference symbol or other distinguishing mark (such as a bird with a worm in its mouth), which a reader or potential buyer will recognize as having to recognize as being able to access additional content of information as an supplement to print record 16, here being the print publication, with a correlative and comprehensive source of information being the electronic counterpart.

In some embodiments of the invention, the person 12 has a means to manipulate the information contained in the electronic record 18. For example, the person 12 is provided an access code, login identification, or other means for providing selective electronic access to certain data. By allowing the person 12 to control and manage the content of the electronic record 18, the person 12 can include information in the electronic record 18 far exceeding that contained in the correlating print record 16. In addition to providing increased informational capacity, this system obviates the need for an intermediary (i.e., publication's ad representative) to process and handle the electronic record 18 by entering the data into the electronic record.

Another embodiment of the invention provides for the solicitation of electronic database multiple records from multiple persons of a defined class of persons (advertisers). Such a desired class of persons are persons wishing to place ads in the classified sections of a newspaper(s) and/or other types of publications. The multiple electronic database records can be in the form of the preconstructed template, which contains the further detailed content to the printed record or may contain any information or data that the multiple persons want to communicate to printed record readers (persons 50). The solicitation by the publications ad representatives of the electronic records, in most instances takes place over the phone, by email, using the Internet, or by any other suitable communicative means.

Multiple print records are created by multiple intermediaries (i.e., publication's ad representative), such as ad-taking representatives of newspapers or other periodicals, using the data provided by the multiple persons, such as advertising persons 12. In addition to the multiple print records, multiple electronic records are also created and are accessible over a communications network, e.g., via provider 60. The data contained in either the multiple print records or the multiple electronic records can include text, images, contact information, or geographical information leading to the location of the item being offered. As shown in FIG. 3, the multiple print records are then published in multiple print periodicals 48, which employ an indicia 26 that indicates to a reader or potential buyer the existence of the corresponding electronic records or database.

In another embodiment of the invention, multiple persons 12 are provided access to manipulate the information contained in the multiple electronic records 18. Such access can be accomplished either through giving the multiple persons 12 an access code, login identification, or by other means for providing electronic access to certain data. By allowing the multiple persons 12 to control and manage the content of the multiple electronic records, the multiple persons 12 are able to include information in the multiple electronic records far exceeding the information contained in the correlating multiple print records. Again, in addition to providing increased informational capacity by giving the multiple persons 12 the ability to submit and edit their own information contained in the multiple electronic records, the multiple intermediaries handling the publication (i.e., publication's ad representatives) of the multiple print records do not have to devote their time to the chore of entering the multiple persons 12 data into the multiple electronic records.

An additional feature of the present invention is the availability of the multiple electronic records from a single source provider 60, even though the multiple print records are dispersed in multiple print periodicals 48 as shown in FIG. 3. The single source provider 60 maintains the availability of the multiple electronic records across a communications network, such as the Internet. For instance, potential buyers may access all of the multiple electronic records that correspond to the multiple print records from a single uniform resource locator (URL) on the Internet. Such a limitless and consolidated availability immeasurably increases the likelihood that prospective purchasers will find items of interest, and ensure that multiple persons 12 gains maximum exposure for their offerings.

The method further provides a second group of persons 50 (ad readers/buyers) from a second defined class of persons, who have previously accessed one or more printed records from one or more publications 48 and which have been alerted by the indicia located in the printed record(s), to the presence of one or more of the multiple electronic records available on the provider's website 60. The second defined class of persons may include any prospective purchasers or persons interested in any services or opportunities set forth or offered in the multiple electronic records 18.

The second group of persons 50 can search and retrieve database fields of subsets or individual database fields correlating to items of interest (by classified sections and subsequently subsections located in the printed record 48) previously entered by the persons 12 into the electronic records. This subset of electronic records can be searched and retrieved by persons 50 by narrowing the selection of electronic records according to designated search criteria 58. Designated search criteria 58 may include category, subcategory, and/or item type, descriptive keywords, or items wanted within a certain radius, which can be searched in a designated geographical area.

Upon selecting a subset of electronic records containing items offered or services of interest to persons 50, a travel itinerary 56 is created, depicted in FIGS. 2 and 5. The travel itinerary 56 employs geographical location information contained in each of the electronic records contained in the subset of electronic records, and may be presented in the form of an illustrative map, sequential driving directions, or any other means of conveying travel information. The travel itinerary 56 advises a prospective buyer as to a recommended travel route from persons 50 predetermined starting point in order to visit the locations of greatest interest contained in the subset of electronic records in an logical and expeditious order. The travel itinerary 56 may be modified according to designated preferential criteria as well, such as shortest travel distance or shortest travel time.

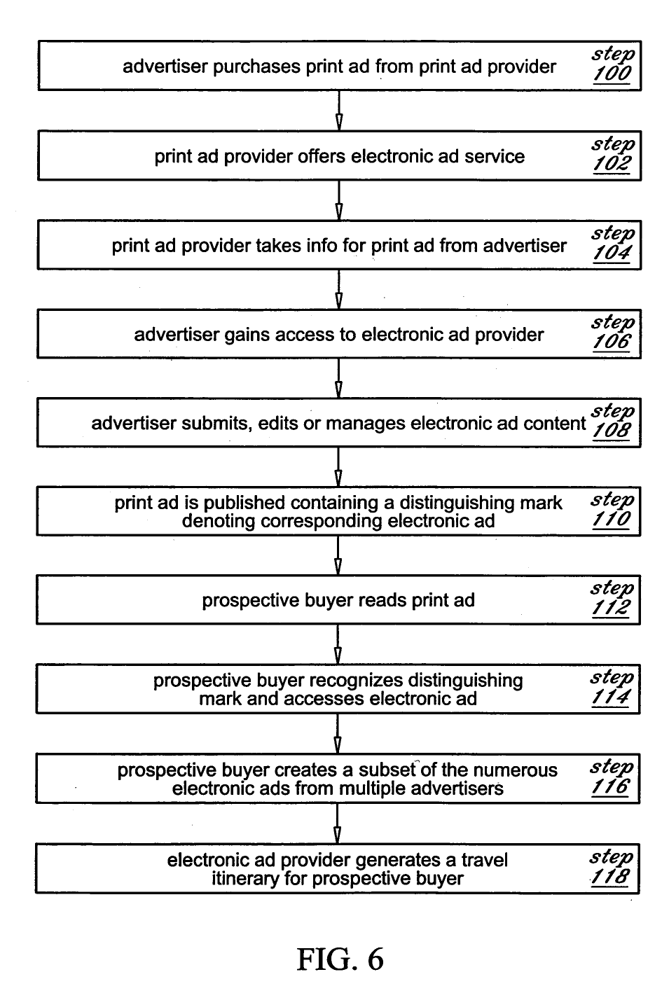

Now referring to FIG. 6, an exemplary embodiment of the present invention is applied to a tag sale (also referred to as ‘garage sales’ or ‘yard sales’), in which an individual wishes to sell items at their home or at another location. The person holding the tag sale, herein called the advertiser/seller, seeks to purchase and/or place a print ad in a local newspaper or other type of publication, as shown in Step 100. Upon initially contacting the publication to purchase a classified type ad, the advertiser submits information to be contained in the print advertisement, and, as shown in Step 102, is subsequently solicited by the publication's representative in order for the advertiser to include additional content in an electronic advertisement as an addendum to her print ad.

Opting for the electronic advertisement in addition to the customary print advertisement, the advertiser submits the content to be placed in the print ad, and then receives access to submit and edit information in the electronic advertisement, shown in Steps 104 and 106. As illustrated in Step 108, and further shown in FIG. 2, the advertiser may then manipulate the content of the electronic ad and has the ability to add an unlimited amount of written information plus photos to supplement the print advertisement in which the individual is constrained by the cost involved in adding additional lines and/or further information to the printed ad. Information in the electronic advertisement may include pictures and descriptions of items, commentary or services for sale, as well as the option to include an address or location where the goods are available to be viewed.

The print advertisement is then published in the local newspaper, and the print advertisement contains a distinguishing mark indicating that the advertiser has opted for the service to include additional content in an electronic ad as indicated in Step 1 10. The potential ad reader/buyer viewing the printed ad with the distinguishing mark is now alerted that there is additional correlative and comprehensive content as an addendum to the printed ad in the electronic advertisement. The potential buyer seeks out the electronic advertisement by accessing a designated website, and views the additional information pertaining to the goods of the advertiser, shown in Steps 112 and 114 of FIG. 6.

The same buyer can also view electronic ads placed by other seller/advertisers and or placed in other newspapers, as shown in step 16 of FIG. 6. For example, in the case of a tag sale, the seller can now detail every item she has for sale rather than only stating “furniture” in her printed ad. With the electronic advertisement, she can now describe every piece of her bedroom and/or dining room sets, including pictures and written descriptions of each particular piece of furniture.

The website providing access to the electronic advertisement contains advertisements from numerous advertisers, and also published from countless publications, each attempting to inform potential buyers of the goods available for sale at their individual tag sales. Although the corresponding print advertisements may appear in various newspapers available in different regions, all of the corresponding electronic advertisements are available for access on a single and/or possibly a plurality of designated websites, as shown in FIG. 3. A potential buyer may create a subset of electronic ads of interest by searching through the electronic advertisements, obtaining a narrowed selection of electronic advertisements using keywords, item descriptors, or geographical location, shown in Step 116 of FIG. 6.

Upon identifying those electronic advertisements that are of interest to the potential buyer, the website processes the selection and provides a travel itinerary, as shown in Step 118 of FIG. 6, and also in FIG. 5, in the form of a detailed map and sequential driving directions. The travel itinerary advises an expeditious route or travel plan enabling the potential buyer to visit the locations having items of interest as quickly as possible and/or in preferential order.

A significant advantage of the invention is that now publications who print classified type advertisements can now make additional profits on each printed ad placed in their paper without any additional labor cost or expense to accomplish this feat. Of most importance to the publishers of classified ads, they can now compete on a “level playing field” with the multitude of Internet websites which have cut deeply into their advertising ad volume and revenue. This invention should restore and recapture the ad volume these publications once enjoyed before the advent of the Internet.

In preferred methods of the invention, printed classified advertisements (brief one or two line ads) that are printed in local and/or national newspapers and/or magazines and other type of publications are provided with a designation indicating related and expanded content on a certain website(s) entered into a database by the advertiser/seller herself. Persons placing the ads are given controlled access to the site where extensive information about the item(s) they have “for sale,” (e.g., photos, commentary, etc.) is entered and/or fully detailed by the seller.

Ad readers then visit the website where the designated ads from the local newspaper are noted, as well as those designated in participating neighboring, regional and/or national newspapers (and/or magazines, trade papers, and other types of publications in which similar classified advertisements are placed in such as Want Ad Digest) which can be made available, searched and/or be reviewed by the reader in an extensive, comprehensive and/or specified fashion and/or further described on a preconstructed database form.

The method of the invention also gives the reader a self-chosen radius in distance from their designated starting point (e.g., their residence) with explicit “door to door” driving directions and/or map views which are generated by the website to lead the ad viewer (and now potential buyer) to a series of classified advertiser's (seller's) locations/addresses based on the buyer's own preselected specifications (e.g., item type, mileage radius from their home, location of sale, price, year, make, model, etc.) in the most expedient and logical order.

In an exemplary method of the invention, brief published ads are placed by the seller in their local newspaper's classified section (or Want Ad, etc.) for a “Garage Sale,” “Yard,” and/or a “Tag” sale. The option to have a more comprehensive listing through the system of the invention is promoted by the newspaper's own classified advertising representatives at the time the advertiser places the classified printed ad. Upon opting for this system designation, the advertiser/seller accesses the website of the invention using a code number assigned to them by the newspaper's classified selling representative which allows the seller to enter any additional items, commentary or further details about a particular item(s) the seller wishes to add, including but not limited to time, place, rain date, categories of items, specific items for sale, prices, photos, etc., on a distinct database form (appropriate to the specific classified listing category and/or subcategory) already constructed on the website of the invention.

The ads are printed in the newspaper and participating ads are marked with a symbol or word indicating participation in the enhanced on-line system of the invention. Buyers (readers) view the paper, access the system website and perform a search for items by location or any other description and/or designator of interest to them. A preselected list of locations is generated by the buyer's own predetermined and/or designated items of interest and/or mileage radius (they wish to travel) along with “door to door” sequential and detailed driving directions and/or instructions and/or map view (from the buyers designated starting point) so that a buyer can visit the most tag sale sites in the most expeditious manner during the course of the day and also take into account and/or factor in perhaps the short time span that most sales are conducted.

For example, a buyer can easily develop a list of locations or Garage Sales to visit (along with explicit and visual driving instructions placed in logical order) to buy, for example, antiques, pictures, appliances, a diningroom set, golf clubs, etc., within a preselected radius of travel. No time is wasted by the buyer going to “tag sales” which perhaps has only “children's clothing” for sale when she is only interested in buying and/or locating antique furniture.

It is far too expensive for the classified advertiser (seller) to list in her printed ad every item she has for sale. The seller is constrained in listing all of her items for sale by the exorbitant cost attributed to listing items exceeding the three or four line limit in the printed “Garage Sale” classified ad. Also it would be far too time consuming, cumbersome and/or unprofitable for the newspaper's classified sales staff to take the time to enter (for her) into a database each and every item the seller wishes to list (even in the unlikely event the newspaper already has their own database alternative to offer the advertiser). For a negligible additional cost to the advertiser/seller (which would be only a fraction of the newspaper's printed four line classified ad cost), the seller can now, utilizing the method and system of the invention, list each and every item she has for sale (with photos and commentary) and achieve far greater exposure for her “Garage Sale” over and beyond the circulation of her local newspaper in which she originally placed her printed classified ad in.

Viewers of the website of the invention will in turn be able to access every participating newspaper's classified ads and not just those printed in any one individual local newspaper. Where it is appropriate for the classified category (e.g., “Houses for Sale” rather than employment or personal ads), the system of the invention will supply both written and/or visual map directions to the location(s) of the classified ad (e.g., Real Estate for Sale, Open Houses to View, Apartments for Rent, Vehicles for Sale, etc.) in sequential order or as specified by the buyer's chosen distance radius and/or indivual item preference(s). The viewer can now search the website of the invention by her own individual specifications and/or preferences (e.g., distance, location, residential area, price, year, make, etc.).

The newspaper/publication will charge its classified advertiser an additional fee for the invention's unique service which will be shared between the newspaper and the system of the invention. All system listings will come through or be solicited by the newspapers only and the system of the invention will not solicit any individual classified advertisers on it's own. The system and method of the invention will substantially increase the newspaper's classified advertisement revenue as well as be more effective and efficient in selling (and/or locating) items “For Sale.” At the same time, the buyer can get more information about the item being sold and locate these items easier than with any other available or conventional method of just reading the traditional 3 or 4 line classified printed ad placed in their local newspaper. In addition, the buyer has a wider selection of items “For Sale” to choose from as the system and website of the invention includes (but is not limited to) every participating newspaper and/or other publication's classified ads and not just the classified ads printed in the buyer's local newspaper in which their printed ad was originally placed.

The invention has further applications to every other classified category listed in any one newspaper's classified section. A multitude of brand new, innovative and unique classified categories exist which lend themselves to the system and method of the invention and which currently do not appear in any newspaper or other type of publication. The system of the invention is preferably configured for world wide operation and includes a plurality of regional newspaper services. In accordance with system design and as will be described in further detail below, the system processor receives the collected ad database record information from the respective newspaper's advertiser. In turn, the system arranges the record information by category and subcategory, predetermined preferences, and by predetermined sort order based on ad selection parameters. In this regard, the predetermined preferences typically provides for the placement of ads at the beginning of any electronic ad record supplied to the system as a result of the party placing the printed ad having paid a premium or special fee for use of the system service to that particular publication. This fee is collected by the publication at the time the advertiser places the printed advertisement.

As will be appreciated, newspaper servers may be located anyplace in the world where connection to the Internet may be effected. In accord with the invention, the system database uses conventional Internet World Wide Web servers and thus supports the hypertext markup language (HTML) and the hypertext transport protocol (HTTP). In preferred embodiments, servers support client terminals equipped with conventional web browsers, as for example, Netscape and Microsoft Explorer. The website of the invention is capable of supporting multi-processing and is able to manage an unlimited number of concurrent users.

The system provides a firewall which prevents unauthorized entry into the database of the invention for persons who have not first placed a printed ad in their local publication. In view of the multitude of publications which are affiliated with the system of the invention, the application server is capable of supporting multi-processing and able to manage thousands of concurrent users. In preferred embodiments, the system provides redundance for purposes of improving system operational reliability and to enable user load balancing. Still further, where system reliability and user loading demands require, additional application servers could also be provided.

In order to simplify support of the system, each individual publication has application software which is provided by the system of the invention, permiting communication with the database of the invention. This Internet communication transport includes a firewall for the purpose of securing its environment. The application software enables the publication to provide the individual advertiser a unique code or an ad record identification number which will allow the advertiser to access the website of the invention in order for the advertiser to enter her additional information (electronic record) on a preconstructed form corresponding to the category of the printed ad she had previously placed in her regional newspaper.

Furthermore, each individual publication generator includes elements for automatically copying the newspaper's ad feed (printed classified ad) into the system database record, which is thereafter included on her electronic preconstructed form. Now the advertiser enters her detailed information, thus creating her own unique electronic ad. In turn, these individual electronic advertisements are collected, sorted and converted by the database server so that users (ad readers) can search and view these records by their own pre-selected criteria and in the most expeditious way and “user friendly” manner.

The predetermined category for the electronic ad is established by the newspaper printing these classified type ads. However, in the case of ads concerning real estate sales, the application server i.e., website of the invention, allows the ad reader or user to search out properties by a number of different variables, such as price, location, square footage, amenities, etc., in order to simplify the user's search results and allow the system to be“user-friendly.”

In preferred embodiments the invention encompasses a classified ad information system and method of operation that include and support: one or more publications where a classified advertiser can add detailed information over the provider's website in addition to her existing brief printed ad; a designated website in which, the ad reader/buyer can access through her personal computer equipped with a modem, the advertiser/seller's printed ad and access additional information pertinent to that particular classified ad if so desired; a network for operationally connecting the user terminals to the application servers; a printed ad record already generated by a particular newspaper and the option for the ad placer/advertiser to choose to add additional information to her ad through the provider's website; the designated symbol, printed in a classified ad, which prompts the user/reader/buyer to access the provider's website to learn more information about that particular ad and/or access similar type of ads that have been printed in one or more publications; one designated database associated with the provider's website to also include in addition to the above; a search processor associated with the respective database at which the ad records are provided for receiving the request message and locating the desired ad records and returning them; an ad template generator for each separate classified section category to receive the classified ad text and/or photos that automatically create a classified ad database record; a collection server for receiving the ad database records created; and

a distribution processor for sorting and organizing the database records created and making them available for use by the public over the Internet.

In preferred embodiments, the classified ad information system of the present invention is adapted for use on the Word Wide Web (Web) of the Internet and supports an international classified ad information system specialized for regional and even national markets. In this form, a plurality of classified ad databases are maintained for a plurality of regional newspapers and other types of publications located throughout the world. In this arrangement each regional or local newspaper solicits the ad placer/advertiser to select the provider's method to enhance her printed classified type ad with detailed information.

The system of the invention links all respective affiliated publications to the provider's centralized database. With this method, in every participating newspaper database, the four or more line classified is entered by the newspaper's own representative into the centralized database of the invention to be searched and retrieved by the public.

Once the advertiser/seller has opted for the system of the invention service, the advertiser/seller is assigned a security code by the newspaper's ad representative. The ad placer then connects to the provider's website and enters her security code which prompts her particular printed ad with a corresponding category template form. She is then given the opportunity to expand upon her printed classified newspaper ad and also to include photos and commentary if she so desires.

The ad reader, in turn, being alerted by the symbol inserted in the printed ad, can choose to access the particular ad to learn more about the item or service being offered. At the same time, the reader can also search for additional similar items published in all participating classified publications whose advertisers' have opted to utilize the present system.

In operation, users interested in viewing the classified ads in a particular region anywhere in the world can connect to the Internet in a conventional fashion and navigate with their Web browser to the provider's home page. On arrival, the user selects the original printed classified ad of interest, which he first viewed in his local newspaper classified ad section and reviews the detailed format which the ad placer herself, filled out on the form contiguous with her ad category.

If after reading the advertiser's informational template on the provider's website, the buyer wishes to pursue the ad offering, the system allows the buyer to contact the seller/advertiser via email through the provider's website without having that email address disclosed to the reader, if she chooses to be anonymous or to protect her privacy. This method also allows the seller/advertiser, if she so chooses, to be shielded from possible superfluous and/or unwanted multiple phone inquiries.

In accordance with the invention, the database includes a search mechanism in which the user navigates the provider's website in Web fashion to a category menu where the user enters a record-narrowing preselection subject matter designation, followed by a navigation to a subcategory menu at the system application server where the user can enter a further subject matter designation to additionally narrow the range of records to be searched and reviewed.

Additionally, the search procedure further includes an application in which the record-request is generated based on ad selection parameters entered by the user/buyer, the request message being submitted to the ad database for retrieval of the desired records which are subsequently reported to the user.

Also in preferred form, and relative to the method aspect of the invention, in order to effect rapid search of the respective ad database by the user as to maintain a short system response time eliminating the normal time-consuming nature of Internet data retrieval, the respective ad database is designed to have a substantial category and subcategory form so that the buyer/reader can simply and quickly retrieve the items previously reviewed, which is retained in RAM of the provider's database server.

Additionally, the respective databases of the individual classified sections of a newspaper, which include the sections and subsections of the publication's classified section, are also designed to have unlimited field lengths dependent on the amount of information the ad placer wishes to enter. The system of the invention allows the user to make comparisons of individual classified ads and various search procedures may be executed with minimal keystrokes involved.

Still further, in order to reduce and simplify the ad record search process, the respective ad database has several phases. The first stage includes ad record category and subcategory identifier tables which the ad placer is assigned by the newspaper's ad representative when she originally places the printed ad. In turn, the newspaper's representative assigns a security code specific to her ad, whereby the advertiser can access the provider's website to add additional content, commentary and photos to her printed ad. This previously assigned personal web page will already be generated with the category and printed three or more line information of the original printed ad at the time she enters it This database is divided similar to most newspapers' standard classified ad sections and subsections and/or categories and subcategories (e.g., Classified Section: Automobiles, Classified Sub-section: Chevrolet).

The next phase includes the data entry content, which the ad placer posts on her assigned web page, which includes a preconstructed template located on the provider's dedicated website. The provider's form corresponds exactly to the advertiser's chosen category item of her printed classified ad. Once being alerted by the provider's designated printed symbol (indicia) in the newspaper that the particular printed ad will have additional content on the website of the invention, the ad reader/buyer, in turn accesses the provider's home page with the ad placer's designated number which has been printed in the ad. At this time the reader can access that particular ad of interest to learn further information about the item/service being offered in the printed ad. Furthermore, the buyer can also access similar designated symbol ads from various publications that participate in the system of the invention and not only the ads placed in the original publication where the first ad was placed. In addition, the ad reader/buyer can access another category of classified sections to find different types of items or services of interest if she so chooses, i.e., Real Estate, Employment, Personals, Boats, etc.

In addition, the method of the invention allows the buyer to retrieve precise “door to door” driving directions including map views to the individual locations of the ads of most interest. Furthermore, if the buyer has chosen several items of interest, this method maps out the most efficient and time-saving driving directions to all locations indicated by the ad reader who wishes to visit and view.

Upon the expiration date of a particular printed classified advertisement, the system automatically deletes the ad placer's personal web page from the provider's database. If the ad placer wishes to place the same ad with similar information at a future date, the system will save her content as an inactive file for an undetermined period of time. In this instance, the advertiser does not have to go through the time-consuming process of re-listing her ad in detail on the system of the invention as it has already saved in it's system her data information for an undetermined period of time.

The system includes elements and steps for providing ad record generation to both speed up the database creation and update process and provide uniformity in item descriptions. Specifically, the system includes a parser located at each of the regional participating newspapers for sending a feed of the printed classified ad text together with classified section information to the provider's database. Once initialized with data including configuration and ad text information specific to a respective newspaper, the respective parser establishes a set of processing tables for the specific newspaper and compares the ad text to the tables in accordance with pre-determined parser rules into a set of standard field values which the parser uses to create a database record.

In preferred embodiments, each participating newspaper or publication ad generator includes an Internet server for sending the database record information created by its respective parser to the provider's database. The respective ad generators are connected to the Internet in conventional fashion and makes the parsed advertisements available for Internet pick-up and delivery.

Still further, a preferred system of the invention also includes a collection server connected to the Internet for collecting the newly created parsed ad records from the participating regional newspapers' ad generator servers in order to be entered into the provider's database using a conventional Internet protocol. The ad record information can be retrieved by the user and is sorted by: category, subcategory, pre-determined preferences and a pre-determined sort order for the ad selection parameters to create the respective database ad records.

### EXAMPLES

### Example 1

### Variations of the System

The system of the invention can be configured to not allow any listing to have a preferential position for an extra charge. All ads can be listed by category, subcategory and in their proper and logical order.

The system of the invention can supply all the software and peripherals necessary (in some embodiments, at no extra cost to the publication) for the newspapers' advertisers to access the system data files themselves in order to enter additional content to their existing printed advertisement. The user of the system can bypass an individual newspaper's “home page,” by going to the system's website instead.

The seller herself can “transmit the data file” with its extended content to her printed ad (not just a temporary e-mail address) to the Service Provider, e.g., the system's website or portal. Renewal ads can be placed through the newspaper directly and not with the system of the invention (the Service Provider). With the system of the invention there is no need to verify the data file because the seller creates her own data file.

System listings (with expanded and detailed information) can be made available to the public (buyer) free of charge

### Example 2

### Ad Searching

Once a user establishes a communication session with the system of the invention, a preselection sequence begins which progressively leads the user to a point where specific ads of interest are requested. As the user progresses from entry, the preselection sequence begins and continues to narrow the range of records eligible to be searched thereby immediately truncating the full electronic ad database, so when the user arrives at the point of entering parameters for ads to view, only a small percentage of the ad database record needs to be accessed. This truncation of the number of records to be queried substantially reduces the time required to search for and retrieve the ad records desired to be viewed.

More specifically, when the user first enters the system, she specifies the category of classified ad to be searched, for example, “real estate,” “jobs,” “personals,” “vehicles,” etc. Thereafter, as the user navigates to the respective selected category, she is further able to specify the subcategory for the particular category selected. For example, where the user wishes to search for items in the classified category “real estate,” a subcategory of real estate, such as residential, commercial, land, farm, etc., would then be selected. Once this hierarchy of category/subcategory is designated, a substantially narrowed range of database records is identified and that narrowed population is searched by entering a formal record selection query containing specific parameters from the electronic records the user wishes to see.

To facilitate selection of the further detailed electronic records by the ad reader, once this narrowed range of ad records is identified (category and subcategory), a subsequent record selection query detailing the specific features of the ads to be viewed is submitted and quickly responded to as the user is sequentially shown the category and subcategory menus. During this process, the system is able to report the number of ads available in each of the subcategories to the user by simply displaying the category/subcategory section.

For example, if the category is “Automobiles,” the system may generate the number “405” noting how many electronic listings are available on the system to view. The subcategory of Automobiles may be “BMW,” where the system may generate the number “25” indicating the quantity of BMWs listed on the system that are available to view in more detail than the brief classified printed ad provides.

The type and number of fields used to accomplish this for each subject matter, category and subcategory vary depending on the nature of the subject matter involved. For example, in the category “Real Estate” and subcategory “residential,” the primary selection parameters might include such features as type of property, e.g., house, condo; the location, e.g., county, town; minimum price; maximum price; minimum number of bedrooms; minimum number of baths; and number of car garage, etc.

To facilitate and narrow the ad reader's selection process, each electronic category form is sorted into the most popular respective fields of the wanted items. In the case where the category is “Vehicles,” i.e., automobiles, and the subcategory is “cars,” the primary selection parameters might include such features as: make, model, minimum year, maximum year, minimum price, maximum price, and mileage, etc. In accordance with the invention, this flexibility and range of presentation is achieved by maintaining the primary selection parameters in either numerical or character form. The system might use numbers for internal processing to achieve compactness and ease of handling, but present the parameters to users in character form, i.e.; words, when displaying them in the search menus. In this way, the system achieves the speed and simplicity of numerical processing while providing the ease of use and understanding associated with descriptive, user-friendly menus.

To further speed the creation of the electronic data record by the advertiser, each category has a preconstructed template corresponding to the advertiser's printed ad category. When the advertiser/seller receives her system access code provided by the publication's representative, in order to communicate with the website of the invention, a blank template form corresponding to her printed classified category appears. The advertiser is prompted by the system to fill in the black fields relating to her item. For example, in the case of a “Personal” ad, the advertiser is prompted to complete the fields in the system's preconstructed form. In “Personals” the fields might be male seeking female, separate fields for all characteristics of advertisers (height, weight, age, education, etc.), and separate fields for the desired characteristics of the person he wishes to meet.

Besides statistical data placed in the pertinent fields by the person seeking out a companion, the system also allows the person placing the listing the opportunity to freely enter any commentary he wishes to communicate. There are certain fields which must be completed by the advertiser in order to for him to be able to proceed with filling out the system's Personals form. The system does not allow the advertiser to continue if certain fields are left blank, because the server must have certain data in order to facilitate the search process for the ad readers. Also, the system provides a browser so that the person listing the detailed ad can retrieve photos from her own personal computer and enter these photos onto the provider's website in order to be viewed on the system's listing form by interested ad readers.

Like primary fields (categories), secondary selection parameters (subcategories) provide details concerning the ad subject matter. However secondary selection parameters additionally provide user-convenient alternative ways of describing the ad subject matter. Specifically, a yes-no field provides features which the user can simply check off in a selection menu to further describe the ad to be viewed. As in the case of the primary parameters, yes-no fields of secondary parameters are category and subcategory-dependent. For example, and again with reference to the category “Real Estate” and the subcategory “residential,” a yes-no field preferably includes such features as: a fireplace, family room, eat-in-kitchen, formal dining room, pool, yard, etc. In the category “Vehicles” and subcategory “cars” on the other hand, yes-no fields may include things like: air conditioning, power steering and brakes, AM/FM Radio, CD Player, manual transmission, ABS, sunroof, low mileage, cruise control, one owner, warranty, leather interior, air bag, etc.

Yet additionally, secondary parameters enable the user to also specify features that may be unique to the item being sought and that are not well suited to conventional classification. Use of pre-defined yes-no fields can be restrictive both where one is seeking to find and/or to advertise somewhat unique items. To provide greater search latitude, secondary selection parameters also include a text field of the actual ad placed. Accordingly, when the user undertakes to enter a record selection query, in addition to specifying primary features and a series of yes-no features, he may also enter a keyword which will be compared against the actual ad text in an effort to locate and match. This feature has the further advantage of providing the user an alternative approach to the search in the event that the primary selection parameters and/or yes-no checkoffs do not provide the results desired. In preferred embodiments, since the ad text is variable in length, the field in the ad record includes a pointer to a suitable location in a suitable storage area and a length designation to designate the length of the text rather than the ad text itself.

The ad records concerns the ad categories and allows a straight forward entry into the stored electronic records. To retain the look and feel of a conventional newspaper print classified ad section, the subject matter categories are selected to be comparable to those commonly appearing in newspapers, for example, “real estate section,” “personals,” and “automotive” (cars, trucks etc.). For the sake of simplicity only a few of the commonly encountered categories for classified ads have been mentioned. A more complete set of categories and subcategories can be used in the implemented system.

The second level of subject matter organization concerns the subcategories for the respective ad categories of the first level mentioned above. Here again, the subcategories are selected to be consistent with those well-understood and familiar to the public and commonly encountered in conventional classified ads. For example, as shown in the case of a real estate category, the category preferably includes subcategories such as: “residential,” “farms/lots/acreage,” “mobile,” etc. A group of suitable subcategories can likewise be provided for each of the other categories.

The system encourages new and unique categories to be added to the existing classified sections of newspapers, for example, restaurants offering “early bird specials.” In this instance, the classified category is “Early Bird Specials.” Each restaurant enters their entire early bird menu on the website of the invention and in turn, the ad reader/diner retrieves these restaurants' “early bird” menus by type of food desired and radius to travel to these restaurants. The conventional classified type ad would make it cost prohibitive for a restaurant advertiser to display their Early Bird menu in print. This can only be accomplished with the electronic data record of the invention. At the same time, the restaurant owner/advertiser enters their Early Bird menu into the database of the invention. They can also place pictures of their restaurant to entice diners to choose their restaurant. The system will give exact written and map view directions to these restaurants from their preselected starting point. The category “Early Bird Specials” is not currently available in any newspaper or other type of publications.

Another unique and novel classified category that this system supports is retail stores' “Discount Sales” or “50% OffSales.” This method allows the retailer to enter into the system data record every item they have for sale and can also include pictures and prices of the individual items offered at discount prices. At the same time, retailers who traditionally advertise their sales through “display ads” can add to their display ad the system indicia alerting the reader/buyer to the existence of expanded information concerning the individual items offered for sale which correspond to the retailer's display ad. For example, a carpet store's display ad might state: “All Carpets and Rugs in Stock 50% Off.” After being alerted by the system indicia located on the display ad, the ad reader now calls up the system website to see pictures and prices of the discounted carpets. As a significant part of the method of the invention, the ad reader is given written directions and a map view to the store(s) she wishes to visit in the most expeditious order within her chosen radius or customized to her preferential order.

Another unique application for the method of the invention is for “Yellow/White Page” directories. In this instance, either the individual “Yellow or White Page” advertisements or listings can incorporate the system by including the system indicia into their ad. This allows the “Yellow Page” reader to learn more about the items or services the business advertiser offers. For example, in the case of the Yellow Page category “Lawyers,” attorneys subscribing to the system service can now, in addition to their display yellow page advertisement, inform the public about their particular expertise, price structure, their educational background and possibly major litigations they have successfully been involved in. In the case of lawyers listed in the Yellow or White Pages who have not purchased a display ad from the “Yellow Page” publishers, they can now list their name, address and telephone number under the Yellow Page category for “Lawyers” or in the White Pages under their last name. By opting for the method of the invention, the indicia is included in their listing notifying the telephone directory reader that she can learn more about the individual directory lister. The directory reader can also see a photo of the attorney in the instance where that attorney has chosen to enter his photo on the electronic database record of the invention. In addition, now in just a “White Page listing,” the lister can even include her email address in the electronic record of the invention she has created.

As is traditional in most “Yellow Page” directory display ads, the advertiser has the opportunity to enter her firm's web page address in the display advertisement. However, individuals or firms choosing a one-line listing in the Yellow or White Pages are not afforded the opportunity to inform the public of their unique web address. With the system of the invention, a one-line lister who opts for the system can now notify the public at a nominal cost of her particular web page address without going to the significant expense of placing a display ad.

The system of the invention combines the classified type electronic ad records with the “Yellow/White Page” directory with the database ad records. In this instance, the ad reader can access their desired information at the same time from both the classified type ads, as for example, published in newspapers as well as those display ads and/or white page listings published in telephone directories. The descriptions of the categories and subcategories presented can be adjusted to suit the tastes both of the newspapers, telephone directories, and or users of the system. As with classified ads, the ad reader/user can access not only those advertisements placed in an individual or regional publication, but have access to all publications' classified ads which are associated or incorporated into the system of the invention.

The method of the invention allows reader/users to access all phone directories published in all regions who also participate in the system of the invention. The system is structured to be able to combine phone directories, newspaper classifieds and other types of publications such as “Want Ads” electronic ads, simultaneously into one or more databases. In another embodiment, two or more separate and unique systems are employed, one for classified type ads and the other(s) for phone directory advertisements and listings without requiring significant change to the database structure.

The respective newspapers and/or phone directory publishers may use category and subcategory descriptions or headers of their own choosing to accommodate regional requirements or preferences, as in the example of a New England publication advertising “winter ski house rentals” which would not be appropriate for a southern publication to have. The system of the invention facilitates uniformity among electronic ad data records generated for common subject matter categories from both newspapers, telephone directories and other type of publications.

In a preferred form of the invention, the subcategory contains items which, while related to the noted category from which it depends, need not provide a further specification of the subject matter to be searched. Particularly, the subcategory may also provide associated items within the specific category; as for example, vehicle insurance within the vehicle category, or marine facilities within the boat for sale category; or technical schools within the employment category, etc.

The combination of parameters (fields) may be “anded” or “ored.” For example, when a record is to be selected the user specifies one or more primary selection parameters and one or more secondary parameters. Further, the user specifies whether the selected parameters are all required to be present in the record, i.e.,“anded” for the record to be selected or whether it would be sufficient if any of the parameters were in the record, i.e. “ored,” in order for it to be selected. For example, a residential real estate search a user, with aid of primary and secondary selection parameters, can look for a very specific house, e.g., a particular location, minimum number of bedrooms, price, and features such as fireplace, family room, eat-in-kitchen, etc. A subcategory is selected by the user by specifying key words such as “mint” or “sacrifice” or “best offer,” etc. Alternatively, the user requests to see a group of houses in different character, but all sharing a common characteristic, e.g., located in a certain town or on a cul-de-sac or having a specific price range or specific keyword such as “waterfront.”

In some embodiments there is no cost to the buyer/ad reader to retrieve information from the system of the invention. In other embodiments, however, the user may be charged a subscription fee. In order to earn additional revenue, advertising may be included on the website, as well as preferential presentation upgrades to an ad, i.e., hierarchy on list or special promotional featuring of their data record at an additional cost.

In some embodiments of the invention, the service subject matter categories include, but are not limited to: Lost and Found, Personals, House For Sale, Apartments For Rent, Apartments/Condos For Sale, Mobile Homes, Employment, Houses For Rent, Business Opportunities, Automobiles, Boats and Accessories, 'rag Sales, Articles For Sale, Professional Services, Auctions, Sales, Heavy Equipment, Pets and Supplies, Employment Wanted, Sport Utility Vehicles, Antiques, Furniture, Open Houses, Truck and Vans, Recreational Vehicles and Motorcycles/Bicycles, etc.

For the sake of brevity, the limited number of categories being presented above are general in character and typical in those commonly found in print classified ads and indeed, may be designed to follow closely the categories used by the publication in its print classified type ads in order to provide familiarity to users and ease of creation. The ads, as previously noted, are prepared by the advertiser for both the print and online data record. At a glance, the user can get a sense of whether or not subcategories will provide the kind of items she is looking for, and, based on the number of ads associated with each, the amount of time and effort to further investigate them.

In some embodiments of the invention, the system includes a single web server. In other embodiments of the invention, the system has multiple, redundant application servers to provide improved reliability and facilitate user load and support increasing data input. The system can include multiple, redundant database servers, each possibly having many independent database software to provide improved reliability and increased load volume.

The system of the present invention replaces the much more complicated SQL based record search process. And because of the ease of data entry and search execution and the user-friendly approach, the system handles the search requirements of multiple and concurrent users with less computing resources then would be possible with other methods.

In preferred embodiments of the invention, the website menu is arranged to present primary and selection parameters/fields referenced “Selection Features” that are likely to be of interest and familiar to buyers and sellers concerned with subject matter associated with the category and subcategory which has been user-designated. For example, in the category of “Houses For Sale,” the primary selection parameters include but are not limited to:

Ad Date and Expiration, Ad as Printed in Publication, Type of Home, Radius of Search, Town, Neighborhood, Development, Minimum/Maximum Price, Minimum Bathrooms, Minimum Bedrooms, etc.

The advertiser is supplied with a comprehensive “House For Sale” electronic form to enter her expanded information plus photos into the data record. The form would allow the advertiser to check off any conceivable amenity which her home might have. For example, such amenities include but are not limited to:

Fireplace; Family Room; Eat-In-Kitchen; Formal Dining Room; Waterfront

Dock; Pool; Washer/Dryer, etc.,

Fill-ins include:

# of Bedrooms, # of Bathrooms, Square Footage, Taxes, Property Size School District, Distance From Shopping, Amount of Closets, Finished Basement, Type of Heat (oil, gas, or electric), Appliances Included, etc.

In the case where the reader/user is satisfied with her search results and does not wish to continue interrogating the ad database of the invention, she either saves the ad/database results reports to her terminal, prints a copy of the report, and/or contacts the advertiser through the anonymous e-mail system of the invention (where the advertisers name and/or address is still unknown to the user) to possibly make an appointment to view the property. Following the completion of the ad search process, the ad reader/user is free to quit the “classified” application and direct her attention to other matters.

Throughout a business day, the publication receives classified ads from the public in conventional fashion, for example, over the telephone, over the Internet, walk-ins, mail-ins, etc. Typically, representatives of the publication's advertising department review the ad text received, make suggestions to improve it, promote the system of the invention option, provide the advertiser with rate information and the actual cost of the proposed ad, and upon approval and price acceptance by the advertiser, secure suitable credit card account and other pertinent payment information.

Once the publication credit checks, verifies and approves the payment method, the advertiser is subsequently sent an e-mail confirming the placement and price of her ad. The print ad itself is now ready to be published for the chosen duration of the ad and the advertiser is given access to the database of the invention to add detailed information, commentary and photos corresponding to her printed advertisement. In accordance with the invention, both a print and electronic record is created and sent to a corresponding file to assure the publication of both the print and Internet segments of the advertiser's classified ad.

### Example 3

### Additional Applications

In addition to tag sale classified advertisements published in newspapers, additional application of the invention exist, for example, the advertisements placed in the newspapers' classified real estate sections, especially homes for sale by owner and/or real estate brokers which are also located at disparate locations. When homes, apartments, condos, etc., are offered for sale or rent by the owner/broker in the real estate section of their local newspaper, potential buyers are confronted with the same difficulties referred to above with respect to tag sales, i.e., the amount of description the advertiser is economically able to place in the printed publication. The method of the current invention can provide multiple real estate opportunities listed in a consolidated electronic source, wherein the electronic listings can have information far exceeding that of the printed listings. The result is similar, if not improved over that provided by the limited access Multiple Listing Service (MLS).

In addition, homes for sale often have an “open house” event in which the public may come and tour the home. These “open houses” are rarely advertised in the classified section of a local newspaper. The owner/broker relies on “open house” signage placed on streets near or in front of the “open house” location to lure prospective (“off the street”) buyers to come in and view the house. This is a “hit and miss” approach to attract buyers. The system of the invention provides an “open house” category in the classified section of regional newspapers. In this example, the advertiser of the “open house” briefly mentions the attributes of the particular home to be viewed in print, while at the same time giving additional comprehensive information, such as price, taxes, amenities, photos, school system, etc., and/or any commentary the advertiser wishes to enter into the electronic ad.

The reader or buyer looking in the “Homes for Sale” category of her Classified Section of her local newspaper typically sees only a 4 or 5 line printed description of a property “for sale.” But information (which is of vital importance for the reader to determine her degree of interest in a particular classified ad) is, by nature, always too lengthy and/or too costly to be included in the normal size printed classified advertisement. In almost all cases, the reader is not given sufficient information in the printed advertisement to determine her interest in the item or service being offered and must always seek out further information by contacting the advertiser herself to decide whether or not a further effort is worthwhile on her part in pursuing this printed offering. With the system of the invention, the reader/buyer has all the information necessary or required at the onset to determine for herself whether to pursue the printed ad further (by perhaps viewing the property itself) or to disregard it and continue to review other “Real Estate” printed offerings.

In addition, the present method allows the prospective home buyer to view a detailed description of the “open house” advertised in the newspaper. With all the information in hand, the prospective buyer can decide whether or not this particular “open house” classified ad meets her criteria and if she has enough interest to view. This prospective buyer performs an advanced search through the application database. At this time, not only can she retrieve all “open houses” available, but prior to that, can enter her desired criteria such as location, price range, square footage, etc., and the database can immediately provide the advanced search results requested.

Note that the prospective home buyer does not first have to read the printed classified ad in her local publication to access and retrieve “open house” listings in the database of the invention. She can simply go directly to the provider's website to access any classified ad in any classified section of any newspaper which elects the service offered by the system of the invention. Consequently, the prospective buyer is not aimlessly looking at houses due to the chance sighting of “open house” signs placed on the streets, which is not in her price range and/or does not satisfy her requirements. The owner/broker/advertiser, in turn, now has a qualified and enthusiastic potential buyer attending the “open house” event who already is knowledgeable of all the pertinent information about the property and is now eagerly viewing it. The system of the invention gives the owner/broker a high potential buyer and a targeted market.

Most “open house” events are solicited by the owner/broker placing “open house” signs on nearby streets to alert prospective buyers (by a chance sighting) that a house is accessible to be viewed during a certain time period. However, doorman apartment buildings, condos, gated communities, and/or secured developments, etc., do not allow the public to come off the street into their buildings or gated communities unannounced or without prior notice. These types of properties can only be viewed “by appointment only.” Thus, owners/brokers cannot place signs to view “open houses” for these guarded types of properties. With the method of the invention, “open houses” for the above type properties can take place and be advertised to the public without any street signs. The present invention allows the seller/broker to place a printed ad for their property in the “open house” classified section of their local newspaper. Opting for the system of the invention of allowing the advertiser/seller to enter additional comprehensive information to the printed ad on the designated database, the advertiser now notifies the ad reader that she must first contact the seller to make an appointment to view the property for sale.

This contact is communicated to the seller through the email service that allows the seller to remain anonymous, which is provided on the website of the invention. A seller wishing to have an “open house” event that will attract the largest attendance can advertise her “By Appointment Only” “open house” for secured type properties without having to place random “open house” signs on the street while producing far more exposure for her property than any “open house” sign (if they were even permitted) could possibly accomplish. This method produces for the seller high visibility, large attendance, as well as serious and knowledgeable viewers of the property and not just uninformed browsers.

The prospective buyers, after researching both the printed “open house” classified ads and subsequently the electronic database of the invention, now determine which locations are of most interest and which they wish to view. In most cases, the seller specifies a limited time where she will be present to show the property. At the same time, the prospective buyer also has a limited amount of time to view the several properties she wishes to see in one day. With numerous locations having “open houses” specifying a limited time window with which to view, such as “Viewing Between 1 p.m. and 3 p.m.,” a prospective buyer must organize her schedule to view as many “open houses” as is possible within a day.

The present method provides a precise, logical and customized travel itinerary which allows the buyer to view the most “open houses” within a specified radius, taking into account the seller's time restrictions, in the most time-efficient manner and/or also in the order of her preference. These explicit maps and driving directions are generated from the items in the electronic database source chosen by the ad reader/buyer on the website of the invention. This system significantly reduces the amount of time required for both mapping, planning and visiting multiple sites of interest. At the same time this method produces for the seller high visibility, large attendance, as well as serious and knowledgeable viewers of the property. Sellers and buyers alike no longer have to advertise and locate “open house” events by the chance passing of an “open house” sign on the street placed by a hopeful owner/broker.

While the invention has been described in its preferred form, it will be appreciated that changes may be made in the form, construction, procedure and arrangement of its various elements, and steps without departing from the spirit or scope of this invention. It will be appreciated that the present invention is not limited to what has been particularly shown and described herein above. In addition, unless mention was made above to the contrary, it should be noted that all of the accompanying drawings are not to scale. The specification and drawings are, accordingly, to be regarded in an illustrative sense rather than a restrictive sense. A variety of modifications and variations are possible in light of the above teachings without departing from the scope and spirit of the invention, which is limited only by the following claims.

What is claimed is:

1. A method for advertising, the method comprising the steps of:
(a) soliciting the creation of a printed record from an advertiser;
(b) creating a print record by the advertiser;
(c) assigning the advertiser a category in the classified section of the publication;
(d) soliciting the advertiser to enter additional information to the printed record on an electronic database;
(e) selecting of the additional service by the advertiser service, wherein the additional information includes photos on the electronic database;
(f) assigning an access code to the advertiser by the publication;
(g) displaying the printed record in at least one advertising section of the publication with a designated indicia indicating to a reader that additional information pertinent to the advertisement is available on the designated website in the form of an electronic record;
(h) accessing, by the reader, of the electronic database and the electronic record associated with the print record over a communications network to review additional information corresponding to the original placed print record; and
(i) retrieving of additional comprehensive information by the reader pertinent to similar printed records from any publication accessible by the electronic database, wherein the advertiser enters additional information corresponding to the printed record, creating an electronic record located on the database of the invention.

2. The method according to claim 1, wherein the print record comprises an advertisement and the electronic record comprises an additional and more comprehensive advertisement corresponding to the original print record.

3. The method according to claim 1, wherein the print record comprises a selected amount of data, wherein the electronic record comprises further data than the print record.

4. The method according to claim 3, wherein the data includes at least one of images, text, and contact information.

5. The method according to claim 3, wherein the data includes geographic coordinates corresponding to the electronic record.

6. The method according to claim 3, wherein data is entered by the advertiser on pre-constructed templates which correspond to the classified categories where the original printed records were placed.

7. The method according to claim 3, wherein the data can be retrieved by the reader includes geographical coordinates attributed to the electronic record.

8. The method according to claim 1, further comprising the step of
(j) publishing the print record in a print periodical.

9. The method according to claim 6, further comprising the step of
(k) providing indicia associated with the print record indicating existence of the corresponding electronic record.

10. The method according to claim 1, further comprising the step of
(l) providing the advertiser with access to manipulation of the data of the electronic record.

11. The method according to claim 1, further comprising the steps of:
(m) allowing a plurality of readers to retrieve additional comprehensive information pertinent to similar printed advertisements printed in a plurality of publications on one or more of the plurality of electronic records;
(n) allowing a plurality of readers to create a subset of electronic records from the plurality of electronic records;
(o) manipulating the data from the subset to create a travel itinerary; and
(p) providing a map illustrating the geographical coordinates contained in the subset of one or more of the plurality of electronic records.

12. The method according to claim 11, wherein the travel itinerary comprises sequential driving directions and/or map views, and the travel itinerary can be modified by the readers and the advertisers by their designated criteria, the designated criteria including at least one of a shortest travel distance, a sequence of travel itinerary in the order of electronic record preference, and a most logical travel sequence.

13. A method for advertising items or services in classified type sections of two or more publications that are located at disparate locations, the method comprising the steps of:
(a) soliciting creation of a plurality of both print and electronic records from a plurality of advertisers;
(b) creating a plurality of print records using data provided by the plurality of advertisers;
(c) creating a plurality of electronic records accessible over a communications network; and
(d) associating and corresponding the plurality of print records with the plurality of electronic records.

14. The method according to claim 13, wherein the plurality of print records comprise advertisements and the plurality of electronic records comprise additional and more comprehensive advertisements corresponding to the original print record placed in a publication.

15. The method according to claim 13, wherein the plurality of print records comprises a selected amount of data and wherein the plurality of electronic records includes more extensive data than the plurality of print records, the data including at least one of images, text, contact information, and geographical coordinates.

16. The method according to claim 15, wherein data is entered by advertisers on pre-constructed templates which correspond to the classified categories where the plurality of printed records were placed.

17. The method according to claim 13, further comprising the steps of
(e) publishing the plurality of print advertisements in a plurality of print periodicals; and
(f) providing indicia associated with the plurality of print records indicating existence of the plurality of corresponding electronic records.

18. The method according to claim 13, further comprising the step of
(g) providing the plurality of advertisers with access to manipulation of the data of the plurality of electronic records.

19. The method according to claim 13, further comprising the steps of
(h) allowing a plurality of readers to access one or more of the plurality of electronic records entered on the designated website previously created by a plurality of advertisers; and
(i) allowing a plurality of readers to create a subset of electronic records from the plurality of electronic records according to a designated criteria.

20. The method according to claim 19, wherein the designated criteria includes at least one of a selected geographic region, a category type or a particular item or service as designated and published in a classified section or any other type of advertisement and in any type of publication including but not limited to phone directories, and a keyword input.

21. The method according to claim 17, wherein the plurality of electronic records are maintained as a single service provider.

22. A method for advertising “tag sales” located at disparate locations, the method comprising the steps of:
(a) providing a plurality of publications that solicit the creation of a plurality of “tag sales” advertisements from a plurality of advertisers placing a plurality of printed classified type ads;
(b) assigning a plurality of “tag sales” advertisers by the plurality of printed publications, as defined as the first class of persons, to the plurality of “tag sales” categories as published in the classified section of a plurality of publications, which the plurality of created print ads appear in print using the data provided by a plurality of “tag sales” advertisers;
(c) soliciting further the plurality of “tag sales” advertisers, as defined as advertisers, who have already created and placed a plurality of printed classified ads or printed records to select the additional added content service which allows the advertisers to enter comprehensive additional information or data to a plurality of printed advertisements on the electronic database over a communications network;
(d) entering additional information by the advertisers including photos on the electronic database after first being assigned an access code by the plurality of publishers' advertisement representatives;
(e) creating a plurality of electronic ads by the “tag sale” advertisers accessible over a communications network;
(f) creating a plurality of print advertisements using data provided by the plurality of “tag sales” advertisers;
(g) print a plurality of “tag sales” print advertisements in a plurality of print periodicals;
(h) providing an indicia associated with the plurality of print advertisements indicating the existence and accessibility to the plurality of electronic advertisements;
(i) displaying the plurality of printed records in the plurality of the publications' classified advertisement sections or other types of advertising sections with a designated indicia indicating to the plurality of readers that additional information pertinent to the plurality of “tag sales” advertisements are available on the electronic database;
(j) allowing the association of the plurality of print advertisements to correspond with the plurality of electronic ads;
(k) accessing of the designated website by the plurality of “tag sales” readers over a communications network to access and retrieve the previously created plurality of electronic records associated with the plurality of classified “tag sales” print advertisements, wherein the plurality of the readers, after reviewing the plurality of the original classified print advertisements which had previously motivated their further interest can learn more details about their preselected “tag sales” offerings;
(l) providing the readers with the opportunity to access and retrieve the plurality of electronic records, which include additional comprehensive content, listing every item offered at the plurality of “” tag sales”, corresponding to the limited amount of information offered in the plurality of similar printed “tag sales” advertisements;
(m) allowing a plurality of potential buyers to select one or more of the plurality of electronic records;
(n) providining access to the plurality of “tag sales” advertisers to manipulate the data of the plurality of electronic advertisements, wherein the plurality of electronic ads are accessible from a single source on a communications network,
wherein the plurality of print advertisements include a selected amount of data and wherein the plurality of electronic advertisements comprise more detailed data than the plurality of print ads, the electronic data record includeing geographical coordinates;
(o) providing a travel route to the geographical coordinates from a designated starting point contained in the selection of one or more of the plurality of electronic records,
wherein the travel route can be modified by the plurality of the readers' designated criteria;
(p) charging and billing the plurality of the advertisers for the additional service of adding a plurality of additional information and/or data to the electronic database.
